(19) United States
(12) Patent Application Publication
(10) Pub. No.: US 2022/0343895 A1
(43) Pub. Date: Oct. 27, 2022

(54) USER-DEFINED KEYWORD SPOTTING

(71) Applicant: FLUENT.AI INC., MONTREAL (CA)

(72) Inventors: Vikrant Singh TOMAR, MONTREAL, QUÉBEC (CA); Samuel Russel MYER, MONTREAL, QUÉBEC (CA)

(21) Appl. No.: 17/637,126

(22) PCT Filed: Aug. 24, 2020
(86) PCT No.: PCT/CA2020/051156

§ 371 Date: Feb. 22, 2022

Related U.S. Application Data
(60) Provisional application No. 62/890,335, filed on Aug. 22, 2019.

(51) Int. Cl. G10L 15/06; G10L 15/16; G10L 15/22; G10L 15/12; G10L 25/78

(52) U.S. Cl. CPC G10L 15/063; G10L 15/16; G10L 15/22; G10L 15/12; G10L 25/78; G10L 2015/088

(57) ABSTRACT

A system and method of learning and recognizing a user-defined keyword is provided. An acoustic signal is obtained comprising speech. An end-user is given ability to train keywords or wake words or their choice just by speaking to the device a few times generating prototype vectors to be associated with the keyword. These keywords can be in any language. At least one of a plurality of keywords or absence of any of the plurality of keywords is predicted utilizing prototype vectors generated from the training of the device.

### CROSS-REFERENCE TO RELATED APPLICATIONS

This application claims priority to U.S. Provisional Application No. 62/890,335 filed Aug. 22, 2019 the entirety of which is hereby incorporated by reference for all purposes.

### TECHNICAL FIELD

The present disclosure relates to methods devices and systems for recognizing keywords that can be defined by the end-user.

### BACKGROUND

Keyword spotting is a common task for speech recognition systems where such a system is trying to detect when a particular keyword is spoken. Such a system can be programmed or trained to detect one or multiple such keywords at the same time. One prevalent use of keyword spotting is to listen for a wake phrase, which is a word or short phrase that can be used to address a device. This task is an important part of voice user interfaces since it allows a user to address commands or queries to a device by speaking a special keyword before the command. For example, one could say “Computer, turn on the lights.” In this case, “Computer” is the wake word, and “turn on the lights” is the command. In idle mode, the voice interface will listen to incoming audio for the keyword to be spoken. Once it detects the keyword, it triggers the other functionality in the system responsible for performing full recognition on the spoken utterance, however, such full recognition functionality is more computationally complex, i.e., demanding more resources and power. Therefore, the accuracy of the initial keyword spotting system is crucial for optimal performance of such a system.

Current keyword detection systems can only work with a limited number of predefined keywords. Often, however, users would like to choose their own keywords to use with the voice interface. These are referred to as “personalized”, “custom”, “user-defined” or “user-trainable” keywords. A keyword detection system should use a small model that can run at low power, and maintain a very small false accept rate, which is typically not more than one false accept per few hours of speech, while still having a reasonably low false reject rate. It is difficult to develop an efficient personalized keyword detection system for a number of reasons. First, the system must be able to learn the personalized keywords from a very small amount of data. It is impractical to ask the user to record more than 3-5 examples of the keyword. However, it is very difficult to achieve an acceptable false accept/false reject rate with limited examples. By comparison, recent work by has used over 10000 examples of each keyword, and still reported a false reject rate of 4% at 0.5 false alarms per hour (see Tara N. Sainath and Carolina Parada, “Convolutional neural networks for small-footprint keyword spotting,” Interspeech, 2015). Second, such a model needs to be fast and small enough to train on a user's device, which is where many keyword spotting systems are deployed. Current models require a lot of computational power to train, and cannot be practically trained on an embedded device.

Additional, alternative and/or improved keyword spotting systems that can be trained to spot custom keywords are desirable.

### BRIEF DESCRIPTION OF THE DRAWINGS

Further features and advantages of the present disclosure will become apparent from the following detailed description, taken in combination with the appended drawings, in which:

FIGS. 1A and 1B depict keyword spotting systems implemented on a user device;

FIG. 2 depicts details of keyword enrollment functionality of the keyword spotting system of FIGS. 1A and 1B;

FIG. 3 depicts a dynamic time warping process for use in keyword spotting;

FIG. 4 depicts a graph of audio frame alignment in a dynamic time warping process;

FIG. 5 depicts a prototype vector encoder used for use in keyword enrollment;

FIG. 6 depicts details of the prototype vector encoder used in keyword spotting;

### DETAILED DESCRIPTION

In accordance with the present disclosure, there is provided a method of training a computer device for detecting one or more custom keyword comprising: receiving at the computer device a plurality of keyword samples each comprising speech sample of the custom keyword; training one or more keyword detectors using the plurality of keyword samples, where one of the keyword detectors learns by a prototype network by: for each keyword sample of the plurality of keyword samples, generating a vector encoding; averaging the generated vector encodings of the plurality of keyword samples to generate a prototype vector; and storing the prototype vector associated with the custom keyword.

In a further embodiment of the method, at least one of the one or more keyword detectors uses a meta-learning network.

In a further embodiment of the method, training the meta-learning network comprises training a neural network on episodic audio data for distinguishing between target keywords and filler or similar-sounding non-keyword utterances.

In a further embodiment of the method the meta-learning network comprises at least one of: a prototypical network; model-agnostic meta-learning (MAML); and matching networks.

In a further embodiment of the method, the method further comprising generating a plurality of frames from the speech sample; for each frame of the plurality of frames generating a respective feature vector; and storing the respective feature vectors in association with an indicator of the custom keyword.

In a further embodiment of the method, the respective feature vectors is at least one of: a Mel-frequency cepstral coefficients (MFCC) feature vector; a log-Mel-filterbank features (FBANK) feature vector; a perceptual linear prediction (PLP) feature vector; a combination of two or more of MFCC, FBANK and PLP feature vectors, and a feature vector based on at least one of MFCC, FBANK and PLP feature vectors.

In a further embodiment of the method, further comprising one or more of data augmentation techniques: artificially adding noise to the speech sample; artificially altering the speed and/or tempo of the speech sample; artificially adding reverb to the speech sample; and applying feature masking to the respective feature vectors generated from the speech sample.

In a further embodiment, the method further comprising receiving user input at the computer device for starting keyword training; and in response to receiving the user input, generating at least one of the plurality of keyword samples from an audio stream.

In a further embodiment, the method further comprises: receiving user input at the user-device for starting keyword enrollment; and in response to receiving the user input, generating at least one of the plurality of keyword samples from the audio stream.

In a further embodiment of the method, the each of the at least one of the plurality of keyword samples are generated when voice activity is detected.

In a further embodiment of the method, the one or more keyword detectors utilizes dynamic time warping (DTW) to detect presence of the custom keyword.

In accordance with the present disclosure, there is provided a method of detecting a custom keyword at a computer-device comprising a multi-stage keyword detector: processing an audio signal by the computer-device, the audio signal containing speech by a keyword detector to determine if a user-trained keyword is present in the speech of the audio signal; and comparing the audio signal to one or more prototype vectors associated with the custom keyword trained by an associated user; wherein when it is verified that the custom keyword is present in the audio signal, outputting a keyword indicator indicating that the custom keyword was detected.

In accordance with the present disclosure, the keyword detector uses a meta-learning network.

In accordance with the present disclosure, the meta-learning network comprises at least one of: a prototypical network; model-agnostic meta-learning (MAML); and matching networks.

In accordance with the present disclosure, the keyword detector compares a prototype vector generated from a plurality keyword training samples to a query vector generated from the audio signal.

In accordance with the present disclosure, a distance metric is used to compare the prototype vector to the query vector.

In accordance with the present disclosure, the distance metric comprises at least one of cosine distance or Euclidean distance.

In accordance with the present disclosure, the distance between the prototype vector and the query vector is less than a threshold distance, the custom keyword associated with the prototype vector is verified to be present in the audio signal.

In accordance with the present disclosure, there is provided wherein multiple thresholds are used for different keywords.

In accordance with the present disclosure, the method further comprises: capturing at the computer-device a plurality of keyword training samples; training the prototype keyword detector using the plurality of keyword training samples.

In accordance with the present disclosure, the method further comprising one or more of: artificially adding noise to at least one of the keyword training samples; artificially adding reverb to at least one of the keyword training samples; applying feature masking to feature vectors generated from at least one of the keyword training samples.

In accordance with the present disclosure, there is provided wherein the keyword detector comprises a prototypical Siamese network.

In accordance with the present disclosure, there is provided a first set of layers of the prototypical Siamese network is initialized by using transfer learning on a related large vocabulary speech recognition task.

In accordance with the present disclosure, the method further comprising a voice activity detection (VAD) system to minimize computation by the keyword detector, wherein the VAD system only sends audio data to the prototype keyword detector when speech is detected in a background audio portion.

In accordance with the present disclosure, the method further comprises triggering an action associated with the custom keyword when a presence of the custom keyword in the audio signal is verified.

In accordance with the present disclosure, the action comprises recording a user query which follows custom keyword detection for further decoding.

In accordance with the present disclosure, the keyword detector uses dynamic time warping (DTW) to determine if the user trained keyword is present.

In accordance with the present disclosure, DTW uses feature vectors generated from frames of a speech sample.

In accordance with the present disclosure, the feature vectors comprise at least one of: a Mel-frequency cepstral coefficients (MFCC) feature vector; a log-Mel-filterbank features (FBANK) feature vector; a perceptual linear prediction (PLP) feature vector; a combination of two or more of MFCC, FBANK and PLP feature vectors, and a feature vector based on at least one of MFCC, FBANK and PLP feature vectors.

In accordance with the present disclosure, DTW alignment lengths and similarity scores are used to determine start and end times of the keyword.

In accordance with the present disclosure, there is provided a computer device comprising: a microphone; a processor operatively coupled to the microphone, the processor capable of executing instructions; and a memory storing instructions which when executed by the processor configure the computer device to perform any of the embodiments of the methods described above.

A personalizable keyword spotting system is described further herein that can be trained on device by the end user themselves with only a few repetitions of their chosen keyword(s). An example application of such a system is a household robot assistant, where users would be able to name their robots and “wake” the device by speaking the robot's name. Such a system would provide a personalizable experience to each user.

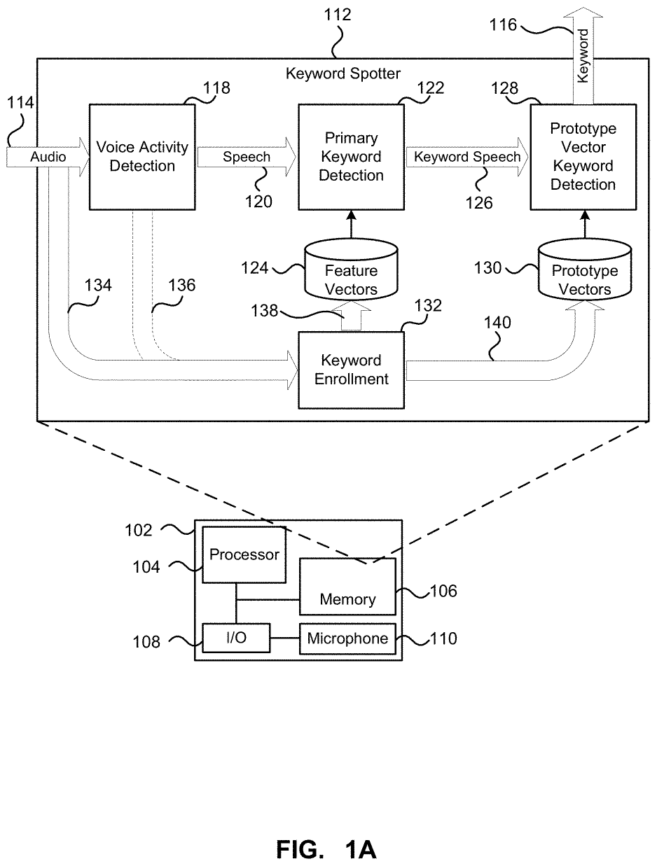

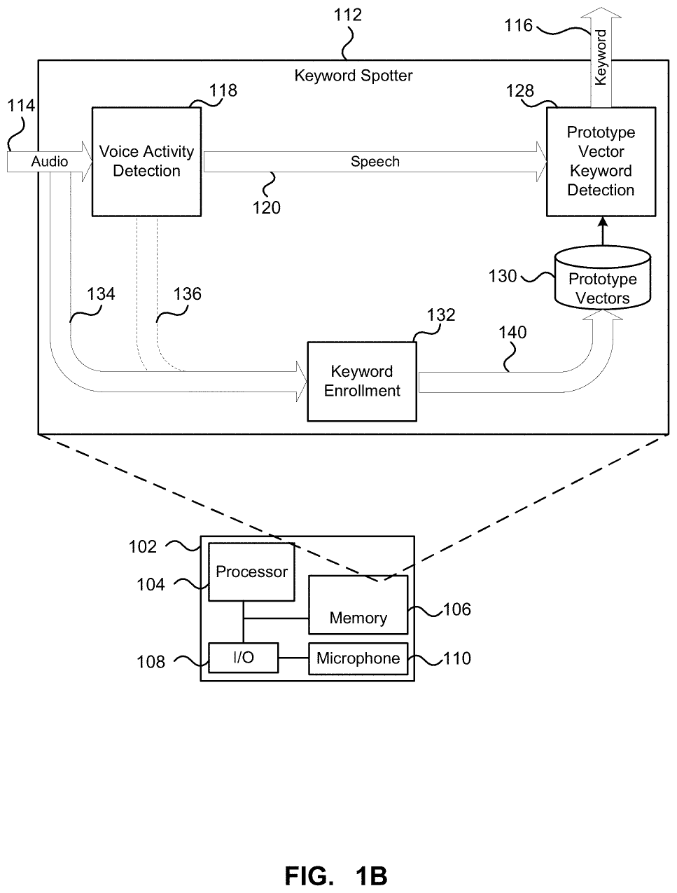

FIG. 1A depicts a keyword spotting system implemented on a user device. A user device 102 may provide a voice interface for interacting with, or controlling, the user device. The user device 102 comprises a processor 104 for executing instructions and a memory 106 for storing instructions and data. The user device 102 may also comprise one or more input/output (I/O) interfaces 108 that connect additional devices to the processor. For example the additional devices connected to the processor 104 by the I/O device may include a microphone 110. Other devices that may be connected may include, for example, keyboards, mice, buttons, switches, speakers, displays, wired and/or wireless network communication devices, etc. The processor 102, which may be provided by, for example a central processing unit (CPU), a microprocessor or micro-controller, a digital signal processor, a field programmable gate array (FPGA), an application specific integrated circuit (ASIC), or other processing device, executes instructions stored in the memory 106, which when executed by the processor 102 configure the user device to provide various functionality including keyword spotting functionality 112.

The keyword spotter 112 receives an audio signal 114 and outputs a keyword indication 116 when a keyword is detected in the audio signal 114. The keyword indication 116 may indicate that a keyword was detected, which one of a possible plurality of keywords were detected, a time at which the keyword was detected within the audio signal 114, an extract from the audio signal 114 that includes the detected keyword, etc. The keyword spotter 112 may comprise voice activity detection (VAD) functionality 118 that receives the audio signal 114 and determines if human speech is present in the audio signal 114. The VAD functionality 118 may comprise an algorithm that processes the audio signal 114 and detects whether it contains any voice activity. Such VAD functionality may be very low-power and may be implemented on a digital signal processor or micro-controller device. An example implementation of such an algorithm is described by L I Jie, ZHOU Ping, JING Xinxing, D U Zhiran. “Speech Endpoint detection Method Based on TEO in Noisy Environment” 2012 IWIEE, which is incorporated herein by reference in its entirety for all purposes. This algorithm may calculate the windowed Teager energy operator (TEO) of the audio signal. A running mean of the windowed TEO values is kept, and the ratio of the instantaneous TEO value to the running mean is calculated. Two thresholds, one for going to the voiced state and one for returning on the unvoiced state, may be used to determine the voiced/unvoiced state. When the ratio exceeds the voiced threshold, the system goes to the voiced state, that is it provides the indication that speech was detected. When the ratio goes below the unvoiced threshold, it returns to the unvoiced state.

When voice activity is detected by the VAD functionality 118, the portion of the audio signal including the speech 120 may be passed to user-trained keyword detection functionality provided by primary keyword detector 122. Although described as passing a signal including the speech, it is possible to provide the audio signal 114 to the user-trained keyword primary detection functionality 122 along with an indication that speech was detected in the audio signal 114. Other ways of providing an audio signal including speech to the user-trained primary keyword detection functionality 122 are possible. The keyword spotter 112 further includes data about a user's chosen keyword, such as feature vectors 124 or prototype vectors 130. As described in further detail below, this data may be generated by keyword enrollment functionality 132 from user input during a keyword enrollment process. The data about the user's chosen keyword or keywords may be provided in other ways than the keyword enrollment functionality 132. Regardless of how the data is generated, it may be stored in memory. The keyword spotting system may use multiple stages for spotting keywords to improve performance. In an example implementation, a two stage keyword spotting system is presented that combines dynamic time warping with a prototypical network to learn and spot user-defined keywords. However, as shown in FIG. 1B a single stage 128 may be utilized where the speech 120 is provided directly to the prototype vector keyword detection functionality 128 for performing keyword spotting. When the primary keyword detection functionality 122 detects an enrolled keyword, it may pass an indication of the portion of the audio signal 114 and/or speech signal 120 that comprises the keyword speech 126. The indication may be a portion of the audio signal 114 or speech signal 120 or may be an indication of a position within the audio signal 114 or speech signal 120 that the keyword speech occurs. The keyword speech signal 126 is received by the prototype vector keyword detection functionality 128. If the prototype vector keyword detection functionality 128 detects a keyword in the keyword speech signal 126 it provides an indication of the detected keyword 116. In this manner, a cascade of multiple stages of keyword detection systems can be used for improved performance. Although two cascaded stages are depicted, a single stage may be used, or additional stages may be cascaded together. It will be appreciated that the indication of a detected keyword may be used by other functionality of the device. For example, a detected keyword may cause other voice processing functionality providing full speech recognition to begin processing the audio signal. Additionally or alternatively, the detected keyword may cause the device to perform an action, such as turning on a light, placing a telephone call, performing other actions possible with the user device, or transmitting an audio sample to a different device for further processing. When a keyword is detected, the user device may provide some feedback to the user indicating that a keyword was detected. The feedback may be, for example, audio feedback, video feedback and/or haptic feedback.

The keyword spotting functionality 112 allows users to enroll personalized keywords or phrases with only having to provide a small number of samples of the personalized keywords/phrases examples. In order to enroll the keyword, the user may speak their personalized phrase a few times while the device is in enrollment mode. While in the enrollment mode, keyword enrollment functionality 132 may receive an audio signal 134, or possibly a speech signal 136 from the VAD functionality 118, that comprises the keyword. The keyword enrollment functionality 132 may provide enrollment data 138 that is stored and used by the primary keyword detection functionality 122 as well as enrollment data 130 that is stored and used by the prototype vector keyword detection functionality 128. An advantage of this approach, as opposed to having the user write the keyword or a pronunciation of it, is that such spoken personalized keyword can be in any language or even in a mix of languages. Thus, as described in further detail below, the user may be prompted to register their keyword by speaking the keyword a plurality of times, such as three times. Silence or background noise may be trimmed from the start and end of the registered audios of the keyword samples to improve recognition accuracy and reduce memory consumption. The trimmed audios of the keyword samples, and/or representations of the keyword samples, may be saved for use by the keyword detection training algorithm, or the keyword detection algorithm. Using this technology, the user may register multiple personalized keywords. These different keywords can then be used to trigger different actions without having to speak another command afterwards.

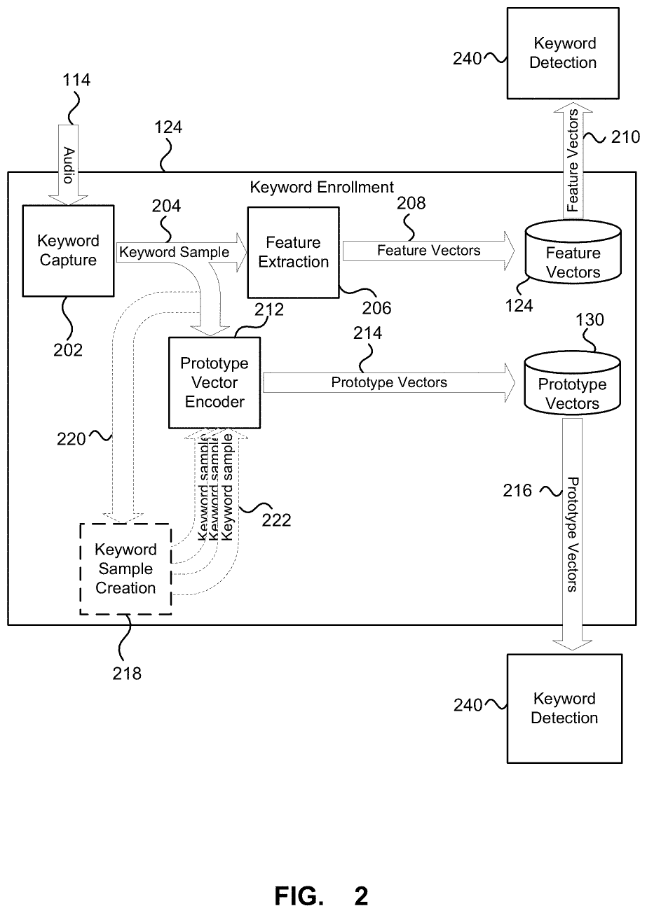

FIG. 2 depicts details of keyword enrollment functionality of the keyword spotting system of FIG. 1. The keyword enrollment functionality 132 comprises keyword capture functionality 202 that captures one or more keyword audio samples 204. The keyword samples 204 may be passed to a feature extraction functionality 206 that generates feature data 208 which may be stored in a keyword feature database 130. The keyword detection functionality 240 may use keyword features stored in the enrolled keyword features database 130 when attempting to detect the presence of keywords in audio. Since the primary keyword detection functionality 122 may use various different algorithms, the feature extraction functionality 206 will generate appropriate feature data 208 which may be stored and the feature data 210 may be provided to the particular user-trained keyword detection functionality 240. As depicted, the feature data may comprise keyword feature vectors although other representations are possible. The keyword detection functionality 240 may be provided by the primary keyword detection functionality 122 using feature vectors 124 or combined with the prototype vector keyword detection functionality 128 for detecting prototype vectors 130 and/or feature vectors 124.

The keyword samples 204 may also be provided to one or more prototype vector encoder functionalities such as prototype vector encoder functionality 212 that takes the keyword samples 204 and generates a prototype vector 214 which may be stored in the enrolled prototype vector database 130. The prototype vector data 216 of keywords may be used by the prototype vector keyword detection functionality 128.

The keyword enrollment functionality 132 may require the user to record multiple samples 204 of the keyword. Additionally, the keyword enrollment functionality 132 may include keyword sample creation functionality 218 that receives a keyword sample 220 and generates multiple keyword sample 222 for each keyword sample recorded by the user. The keyword sample creation functionality 218 may modify the keyword sample 218 in various ways such as speeding up the keyword sample, slowing down the keyword sample, adding noise or other sounds to the keyword sample as well as various combinations of speeding up, slowing down and adding noise/sounds.

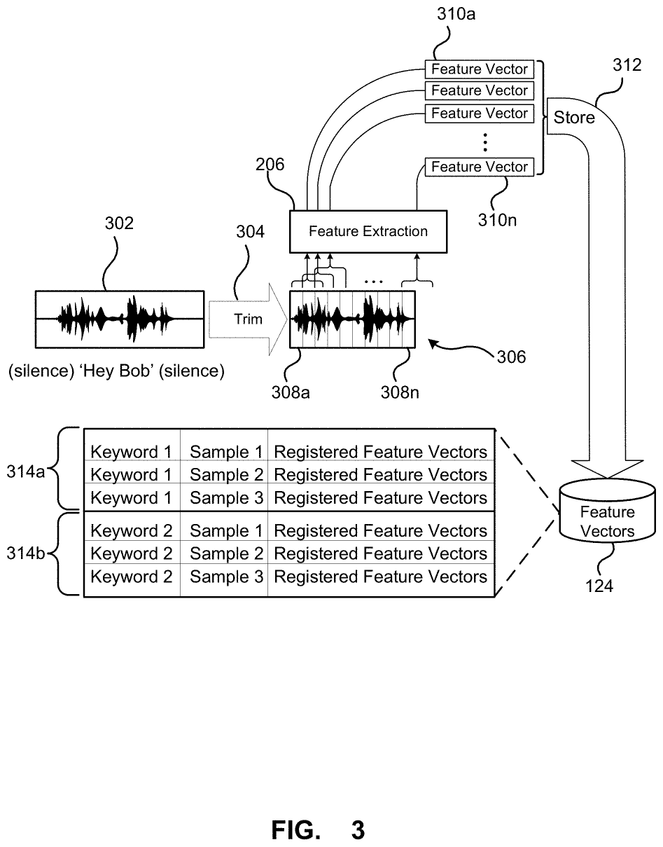

FIG. 3 depicts one embodiment of user-defined keyword detection. In this embodiment, which may be implemented within for example the keyword detection functionality 122, may use dynamic time warping to learn and detect user-defined keywords. An audio signal 302 containing a custom keyword such as “Hey Bob” is captured, and trimmed 304 to remove any leading and trailing silence or noise, which may be done for example by functionality such as the keyword capture functionality 202 described above. The trimmed audio signal provides a keyword sample 306 that may be processed, for example, by the feature extraction functionality 206 of the keyword enrollment functionality 132 described above, to generate features of the keyword sample. The features may be generated using one of various speech feature extraction techniques such as Mel-frequency cepstral coefficient (MFCC), as described in S. B. Davis and P. Mermelstein (1980) “Comparison of parametric representations for monosyllabic word recognition in continuously spoken sentences”, IEEE Trans. Acoust., Speech, Signal Processing 1980: 357-366, which is incorporated herein by reference in its entirety for all purposes, log-Mel-filterbank features (FBANK), or perceptual linear prediction (PLP). Additionally or alternatively, the features may be generated as a combination of two or more MFCC, FBANK and PLP features. Further, new feature vectors may be generated based on one or more of MFCC, FBANK and PLP features. The feature extraction may split the keyword sample 306 into a plurality of short frames 308a-308n (referred to collectively as frames 308). For example each of the frames 308 may be 25 ms in length. The frames 308 may overlap with other frames, for example each 25 ms frame may begin 10 ms after the start of the previous frame. For each of the frames 308, feature vectors 310a-310n (referred to collectively as feature vectors 310) are generated by the feature extraction functionality 206. The feature vectors 310 may comprise, for example, 13 MFCC features that are calculated from the frames. Additionally, the MFCC vectors 310 may include first and/or second derivatives of each of the calculated MFCC features. If the MFCC vectors 310 comprise 13 MFCC features and both first and second derivatives, each of the MFCC feature vectors 310 may comprise 39 features. Once generated, all of the feature vectors 310 may be stored 312 along with other keyword information, for example in a keyword feature vector database 124. As depicted, the keyword feature vector database 124 may store various records 314a, 314b for each custom keyword. Each keyword may have a plurality of samples that associate an indication of the keyword with the plurality of frame feature vectors generated for the respective captured sample of the keyword. The different samples of the keyword may be generated from different samples of the keyword spoken by the user. Additionally or alternatively, one or more samples of a keyword may be generated from the spoken keyword by artificially adding noise and/or reverb to the sample. Further, one or more samples of a keyword may be generated by feature masking one or more features of the generated feature vectors. Once the keywords have been enrolled, the stored feature vectors can be used to determine possible matches with features from a query keyword sample.

The keyword enrollment described above with particular reference to FIG. 3 is described as enrolling keywords with a keyword detection process that uses dynamic time warping (DTW). It will be appreciated that other keyword detection processes may be used, and the enrollment of user keyword samples may be adjusted accordingly. For example, the keyword detection could be implemented by combining DTW with a small neural network (NN-DTW), using a non-negative matrix factorization technique, or using a set of meta-learning neural network models.

Dynamic time warping is used to find an alignment between the input audio and each registered audio at each time frame as described in Timothy J. Hazen, Wade Shen, Christopher M. White (2009) “Query-by-example spoken term detection using phonetic posteriorgram templates” ASRU 2009: 421-426, which is incorporated herein by reference for all purposes. From the alignment, a similarity score for each registered keyword at each time frame is calculated. These similarity scores are averaged to produce an overall similarity at each time frame. When the similarity score goes above a certain threshold, then the keyword is considered to be detected. All keywords may use the same threshold or keywords may have different thresholds.

To calculate the best matching alignment path, a distance metric can be calculated between each frame of the input audio and each frame of the registered audio. The first step in calculating the distance is to extract speech features 310a-310n from the audio input as described above. A cosine distance may be used to calculate the distance between each pair of feature vectors. Using this distance metric, an alignment path is calculated between the input frames and registered audio frames, which minimizes the average distance. This alignment can be constrained so that the time “warp” factor is between 50% and 200%, using the method from Hazen et al. The overall alignment similarity score between the input and each registered audio is calculated by averaging of the distances along the path. This algorithm is implemented in real time. The implementation does not keep track of the path shape, only the similarity score and alignment length.

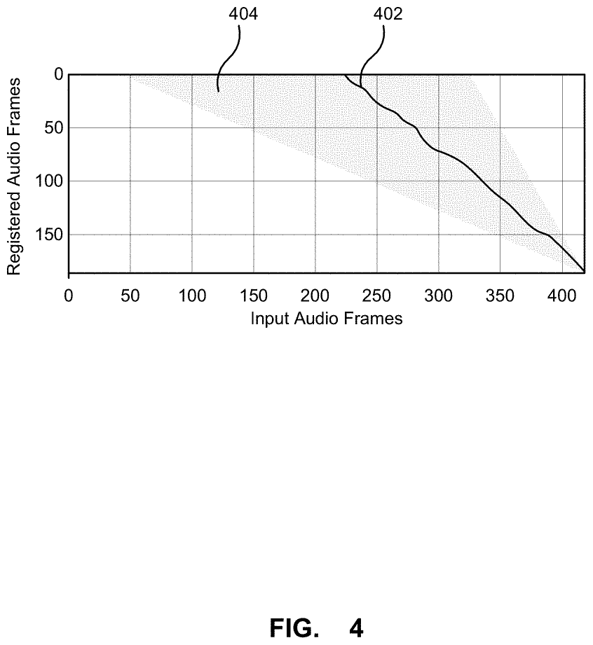

FIG. 4 depicts a graph of audio frame alignment in a dynamic time warping process. The alignment length is the number of input frames needed to align with the registered audio. This corresponds to the horizontal length of the alignment line 402 in FIG. 4. At each time step, the distance between the new input frame and each registered frame feature is calculated, and the path similarities and lengths are updated. If the registered keyword sample is n frames long, then at each time step, the similarity score and alignment length between the input and the first m frames of the registered keyword sample is stored, for each m from 1 . . . n. So, the amount of memory required is proportional to the number of registered keyword samples multiplied by the number of frames n in each keyword sample. As depicted in FIG. 4 the search space 404 between input audio frame and registered audio frames may be decreased as the alignment progresses.

In addition to detecting whether the keyword is present, the system can also find the start and stop time of the keyword. This allows the system to accurately segment the audio when passing to a second stage detector, or when detecting a command following the keyword. After detecting the keyword, the system may continue calculating frame similarity scores and alignment lengths for a short duration afterwards, such as 50-100 ms. The system searches for the frame position with maximum similarity score in that period. This frame with the maximum similarity score may be assumed to be the end time of the keyword. To find the start time, the length of the alignment found at the end frame is subtracted from the end frame time. Following the keyword detection, there may be a timeout period, for example around 1 s, in which no keyword detection is performed, in order to prevent the system from detecting the same keyword multiple times.

The above has described the training and use of a user-defined keyword detection functionality that uses DTW to detect custom keywords in audio. While described with particular reference with regard to DTW, it is possible to perform the initial custom keyword detection using other techniques. Regardless of how the initial keyword detection is performed, the keyword spotting system uses a secondary keyword detection functionality to verify detected keywords. When the first stage detects a keyword, it is sent to a second search function for confirmation, in order to reduce the false accept rate. The second keyword detection functionality may be implemented using a prototypical network, such as described in Snell, Jake & Swersky, Kevin & S. Zemel, Richard (2017) “Prototypical Networks for Few-shot Learning”. However, it could alternatively be implemented using non-negative matrix factorization (NMF) as described in F. Gemmeke, Jort. (2014) “The self-taught vocal interface” 21-22. 10.1109/HSCMA.2014.6843243, or another meta-learning based method, such as matching networks or model-agnostic meta-learning (MAML) as described in Chelsea Finn, Pieter Abbeel, Sergey Levine (2017); Proc. 34th ICML, PMLR 70:1126-1135. References of Snell et al., Gemmeke, and Finn are each incorporated herein by reference in their entirety for all purposes.

Prototypical networks comprise a class of neural networks that are based on the concept that in the neural network's output embedding space, there exist a potential representative point or vector for each class. Therefore, instead of processing all of the data points of each class, the same effect could be achieved by processing this single prototype point or vector. Such networks are trained using a set of techniques called meta-learning, whereby the network “learns to learn”. This method is particularly interesting, since it can be pre-trained on a large amount of data before being sent to the user, and then later learn to recognize user keywords on device with very few examples. A prototypical network could be implemented using a Siamese model that consists of two identical neural networks, with the same architecture and weights. One of the networks is fed the query data, and the other network is fed support data. The distance between the outputs of the two networks is calculated, and a keyword is detected when the distance goes below a threshold.

In the current system, the neural network which is duplicated in the Siamese model functions as a vector encoder, which represents the input features as a vector in a new feature space. The user's keyword samples captured during enrollment are processed by the network vector encoder and combined to generate a prototype vector. Possible keywords that were detected by the initial keyword detection functionality are processed by the network vector encoder to generate a query vector encoding of the possible keyword, which can then be compared to the prototype vector generated from the enrollment utterances to confirm if the detected keyword was present in the audio signal.

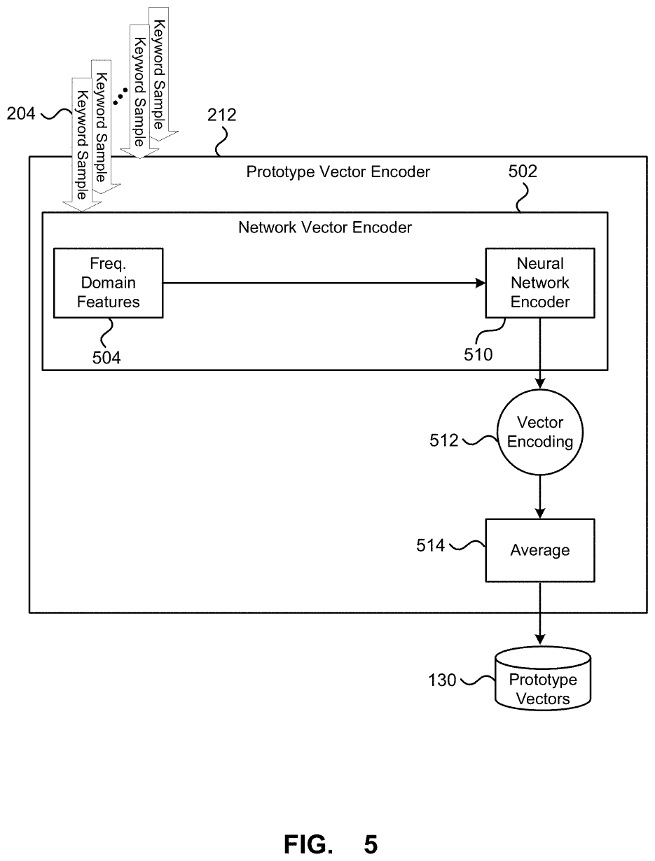

FIG. 5 depicts a prototype vector encoder used in user keyword enrollment. The prototype vector encoder 216 receives a plurality of keyword samples 204 of the custom keyword. Each of the keyword samples 204 is processed by a network vector encoder 502. In the current system, the network vector encoder 502 comprises two components. First, the audio is processed by frequency domain features functionality 504 that generates acoustic features from the input keyword sample. The acoustic features are used as input to neural-network based encoder functionality 510, which outputs a vector encoding 512 of the speech content. In the current embodiment, a recurrent neural network (RNN) is used. However, in an alternate embodiment, different neural network architectures could be used, such as, convolutional network networks (CNN), convolutional recurrent networks (CRNN), attention networks etc. Alternatively, the Neural Network Encoder may comprise multiple neural networks. For example acoustic neural network functionality can be used to extract a sequence of phonetic features from the acoustic features. The sequence of phonetic features in the keyword can then be used by an algorithm that can compute correlation among phones occurring at different time intervals. One example embodiment of this uses histogram of acoustic correlations (HAC) functionality to create an HAC, which is a fixed-length vector which provides a compressed representation of the phonetic data in the audio.

In the prototype vector encoder 212, a plurality of keyword samples 204 are each processed by the network vector encoder 502 to generate respective vector encodings 512. The plurality of vector encodings are averaged together by averaging functionality 514 to generate a prototype vector of the keyword which may be stored in, for example the prototype vector database 130 of the keyword spotter functionality 112. The prototype vector only needs to be created once for each keyword trained by the user. The prototype vector may be used to compare against vector encodings of possible keywords to determine if the keyword is present.

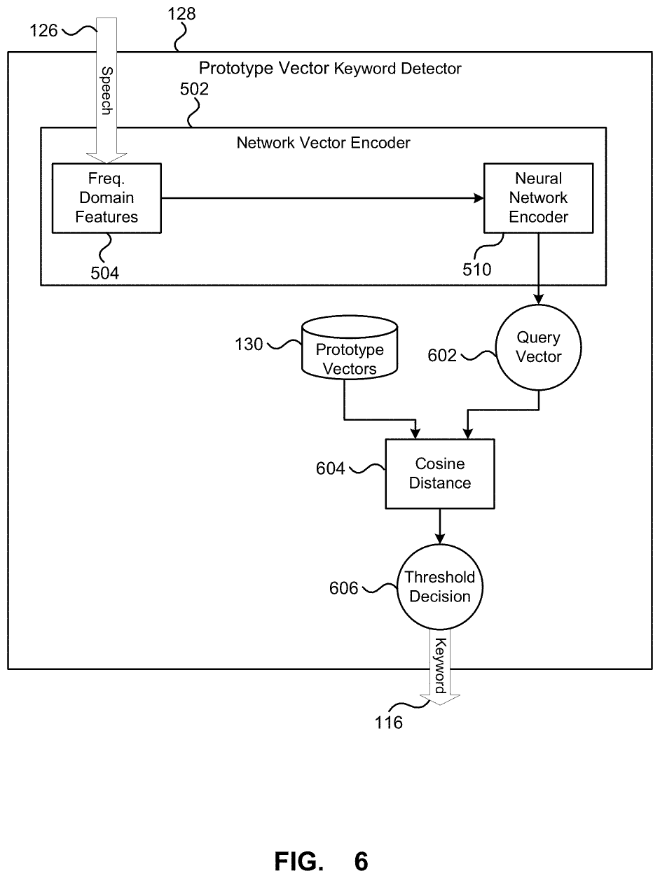

FIG. 6 depicts details of prototype vector keyword detection used in keyword spotting. The prototype vector keyword detection 128 receives keyword speech 126 of a possible keyword that was detected by the initial keyword detection functionality. The keyword speech 126 is processed by a network vector encoder 502 that has the same architecture and weightings/configuration as used by the prototype vector encoder 216. The network vector encoder 502 processes the keyword speech 126 to generate a query vector 602. Distance metric functionality 604 is used to calculate the distance between the query vector and prototype vector of the keyword. A distance metric such as cosine distance metric can used although other comparable distance metrics may be utilized. If the user has trained multiple keywords, the query vector 602 may be compared to the prototype vector for each of the keywords. Alternatively, the possible keyword detected by the initial keyword detection may be used to select one or more prototype vectors for subsequent comparison. If multiple prototype vectors are compared, the keyword with the lowest distance, and so the highest similarly, may be selected as the identified keyword. The calculated distance may be used in a threshold decision 606. If the distance crosses the threshold, for example the distance is at or below a preset threshold value, the keyword 116 is considered as having been detected. The threshold can be adjusted based on the desired sensitivity and empirical results. An example value is 0.35. If none of the keyword distances exceed the threshold, then the component determines that the user said something other than the personalized keyword and the system goes back to the idle state where the audio is processed to determine if there is voice activity present.

In order for the prototypical network to work, it is pre-trained using meta-learning. This pre-training teaches the network to produce vector encodings such that vectors are close together only if they represent the same word. That is, the pre-training of the prototypical network trains the network vector encoder 502 used both during keyword enrollment and keyword detection to generate vector encodings that are close only if they represent the same keyword. The data used to pre-train the network vector encoder comprises several episodes. Each episode comprises a support set and a query set. The support set represents the initial phase where the user teaches the system the personalized keyword. It may comprise 3 examples of a keyword spoken by a single speaker. The query set represents subsequent user queries. It contains several more examples of the same keyword to be used as a positive queries, and several examples of different keywords to be used as negative queries. The support examples are used to generate the prototype vector, and the distance between each query vector and the prototype vector is calculated. Finally, backpropagation is used to minimize the distance between the prototype and the positive queries, while maximizing the distance between the prototype and the negative queries. This process is repeated for each episode of the training data.

To make the keyword detection more robust to noisy and far field conditions, the training data may be enhanced using various data-augmentation techniques, such as by artificially adding noise, speech and reverb to the original recordings, varying the speed and/or pitch of the audio, masking certain frames of the feature vectors with zeros or arbitrary values etc. Various types of noise, such as urban street noise, car noise, music, background speech, babble, may be mixed into the recordings at different signal-to-noise ratios. Reverb may be added by convoluting room impulse responses recorded in various small rooms. In addition, to reduce false alarms, the negative queries in the dataset may include keywords which are similar sounding to the support keywords. This enables the system to better discriminate between the target keyword and similar sounding confusing words. Query data contains keywords spoken by the same speaker as well as different speakers.

When using the prototypical network for live keyword decoding, it must be able to detect the keyword, in the context where the user speaks a command immediately after the keyword. To reduce false rejects in such a scenario, some positive examples in the query set contain utterances where the keyword is followed by a command. During training, a technique called max-pooling loss is used to determine the location of the keyword in the training utterance. For each time index in the query, the output of the neural network is calculated, and the distance between the support prototype vector and the output vector at that time is calculated. The time index where the distance is smallest is chosen to be the location of the keyword, and backpropagation is performed against the network output at that time index only. This technique is used for both positive and negative examples.

Keyword detection can be speaker dependent or speaker independent. Speaker dependent systems recognize both the keyword and the person speaking it, and should not trigger when another person speaks the keyword. This provides additional security, and often additional accuracy as well. Speaker independent systems fire whenever the keyword is spoken, no matter who is speaking it.

The prototype model can be trained to be either speaker dependent or speaker independent by providing examples of the keyword spoken by a different speaker and labelling them as either as true examples or false examples. In the speaker-dependent version, an additional speaker recognition module may be added to reject keyword utterances by different speakers.

The personalized keyword spotting system gives the end user the ability to personalize their keywords. This is accomplished using a system which searches the audio for a personalizable keyword using a user trainable detection process. The detection process uses a prototypical neural network trained using meta-learning. As described above, the detection process may also use a real-time DTW algorithm as a first detection stage before the prototypical neural network. The personalizable keyword can be trained using very few examples, allowing the user to train it on the fly, unlike current systems which require hours of recorded keyword examples to train.

It will be appreciated by one of ordinary skill in the art that the system and components shown in FIGS. 1-6 may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as defined in the claims.

Each element in the embodiments of the present disclosure may be implemented as hardware, software/program, or any combination thereof. Software codes, either in its entirety or a part thereof, may be stored in a computer readable medium or memory (e.g., as a ROM, for example a non-volatile memory such as flash memory, CD ROM, DVD ROM, Blu-ray™, a semiconductor ROM, USB, or a magnetic recording medium, for example a hard disk). The program may be in the form of source code, object code, a code intermediate source and object code such as partially compiled form, or in any other form.

What is claimed is:

1. A method of training a computer device for detecting one or more custom keyword comprising:
receiving at the computer device a plurality of keyword samples each comprising speech sample of the custom keyword;
training one or more keyword detectors using the plurality of keyword samples, where one of the keyword detectors learns by a prototype network by:
for each keyword sample of the plurality of keyword samples, generating a vector encoding;
averaging the generated vector encodings of the plurality of keyword samples to generate a prototype vector; and
storing the prototype vector associated with the custom keyword.

2. The method of claim 1, wherein at least one of the one or more keyword detectors uses a meta-learning network.

3. The method of claim 2, wherein training the meta-learning network comprises training a neural network on episodic audio data for distinguishing between target keywords and filler or similar-sounding non-keyword utterances.

4. The method of claim 3, wherein the meta-learning network comprises at least one of:
a prototypical network;
model-agnostic meta-learning (MAML); and
matching networks.

5. The method of claim 1, wherein training the one or more keyword detector comprises:
generating a plurality of frames from the speech sample;
for each frame of the plurality of frames generating a respective feature vector; and
storing the respective feature vectors in association with an indicator of the custom keyword.

6. The method of claim 1, wherein the respective feature vectors is at least one of:
a Mel-frequency cepstral coefficients (MFCC) feature vector;
a log-Mel-filterbank features (FBANK) feature vector;
a perceptual linear prediction (PLP) feature vector;
a combination of two or more of MFCC, FBANK and PLP feature vectors, and
a feature vector based on at least one of MFCC, FBANK and PLP feature vectors.

7. The method of claim 5, further comprising one or more of data augmentation techniques:
artificially adding noise to the speech sample;
artificially altering the speed and/or tempo of the speech sample;
artificially adding reverb to the speech sample; and
applying feature masking to the respective feature vectors generated from the speech sample.

8. The method of claim 1, further comprising:
receiving user input at the computer device for starting keyword training; and
in response to receiving the user input, generating at least one of the plurality of keyword samples from an audio stream.

9. The method of claim 8, wherein the each of the at least one of the plurality of keyword samples are generated when voice activity is detected.

10. The method of claim 1, wherein the one or more keyword detectors utilizes dynamic time warping (DTW) to detect presence of the custom keyword.

11. A method of detecting a custom keyword at a computer-device comprising:
processing an audio signal by the computer-device, the audio signal containing speech by a keyword detector to determine if a user-trained keyword is present in the speech of the audio signal; and
comparing the audio signal to one or more prototype vectors associated with the custom keyword trained by an associated user;
wherein when it is verified that the custom keyword is present in the audio signal, outputting a keyword indicator indicating that the custom keyword was detected.

12. The method of claim 11, wherein the keyword detector uses a meta-learning network.

13. The method of claim 12, wherein the meta-learning network comprises at least one of:
a prototypical network;
model-agnostic meta-learning (MAML); and
matching networks.

14. The method of claim 11, wherein the keyword detector compares a prototype vector generated from a plurality keyword training samples to a query vector generated from the audio signal.

15. The method of claim 14, wherein a distance metric is used to compare the prototype vector to the query vector.

16. The method of claim 15, wherein the distance metric comprises at least one of cosine distance or Euclidean distance.

17. The method of claim 15, wherein if the distance between the prototype vector and the query vector is less than a threshold distance, the custom keyword associated with the prototype vector is verified to be present in the audio signal.

18. The method of claim 11, wherein multiple thresholds are used for different keywords.

19. The method of claim 11, further comprising:
capturing at the computer-device a plurality of keyword training samples; and
training the prototype keyword detector using the plurality of keyword training samples.

20. The method of claim 19, wherein further comprising one or more of:
artificially adding noise to at least one of the keyword training samples;
artificially adding reverb to at least one of the keyword training samples; and
applying feature masking to feature vectors generated from at least one of the keyword training samples.

21. The method of claim 11, wherein the keyword detector comprises a prototypical Siamese network.

22. The method of claim 21, wherein a first set of layers of the prototypical Siamese network is initialized by using transfer learning on a related large vocabulary speech recognition task.

23. The method of claim 11, further comprising a voice activity detection (VAD) system to minimize computation by the keyword detector, wherein the VAD system only sends audio data to the prototype keyword detector when speech is detected in a background audio portion.

24. The method of claim 11, further comprising triggering an action associated with the custom keyword when a presence of the custom keyword in the audio signal is verified.

25. The method of claim 24, wherein the action comprises recording a user query which follows custom keyword detection for further decoding.

26. The method of claim 11, wherein the keyword detector uses dynamic time warping (DTW) to determine if the user trained keyword is present.

27. The method of claim 26, wherein DTW uses feature vectors generated from frames of a speech sample.

28. The method of claim 27, wherein the feature vectors comprise at least one of:
a Mel-frequency cepstral coefficients (MFCC) feature vector;
a log-Mel-filterbank features (FBANK) feature vector;
a perceptual linear prediction (PLP) feature vector; and
a combination of two or more of MFCC, FBANK and PLP feature vectors, and
a feature vector based on at least one of MFCC, FBANK and PLP feature vectors.

29. The method of claim 27, further comprising using DTW alignment lengths and similarity scores to determine start and end times of the keyword.

30. A computer device comprising:
a microphone;
a processor operatively coupled to the microphone, the processor capable of executing instructions; and
a memory storing instructions which when executed by the processor configure the computer device to perform the method of any one of claims 1-29.
